(19) United States
(12) Patent Application Publication
(10) Pub. No.: US 2013/0193683 A1
(43) Pub. Date: Aug. 1, 2013

(54) HIGH PRESSURE FITTING

(71) Applicants: Derrick Kenneth Seto, San Gabriel, CA (US); Greg Randall Walti, Santa Monica, CA (US)

(72) Inventors: Derrick Kenneth Seto, San Gabriel, CA (US); Greg Randall Walti, Santa Monica, CA (US)

(73) Assignee: HASKEL INTERNATIONAL INCORPORATED, Burbank, CA (US)

(21) Appl. No.: 13/358,626

(22) Filed: Jan. 26, 2012

(51) Int. Cl. F16L 19/00; B23P 11/00

(52) U.S. Cl. 285/331; 285/384; 29/456

(57) ABSTRACT

A fitting assembly for a high pressure system includes a tube assembly including a tube having an undercut near a first end. A gland is slidably coupled around the tube and has an exterior threaded surface. The gland forms a gland cavity adjacent an exterior surface of the tube. A spring collar is also slidably coupled around the tube between the gland and the first end of the tube such that a portion of the spring collar is disposed within the gland cavity. The fitting body has an inlet passage and a fitting cavity for receiving an end of the tube assembly. The open end of the fitting cavity has a threaded surface forming a threaded engagement with the threaded surface of the gland. This threaded engagement creates a primary and secondary seal in the fitting assembly. The secondary seal applies a force to the threaded engagement.

### BACKGROUND OF THE INVENTION

This invention relates to fluid fittings and more particularly to fluid fittings for high pressure fluid systems.

Conventional high pressure fittings include a threaded end of a tube engaged with a threaded bushing such that a seal between the tube and the bushing is formed. A common failure mode of such conventional high pressure fittings is failure of the seal formed at the thread engagement. Such failures can be result in situations where, for example, the pressure of the fluid flowing through the fitting is not always constant. This leads to pressure pulses being experienced in the valve. Because no tension is applied to the engaged threads of these conventional fittings, the vibrations created by this pressure pulsation can cause the engaged threads to loosen and, ultimately, unwind. Consequently, there is a need for a fitting solution that is not susceptible to this failure due to vibration in the fitting.

### BRIEF DESCRIPTION OF THE INVENTION

According to one embodiment of the invention, a fitting assembly for use in a high pressure system is provided having a tube assembly including a tube having an undercut near a first end and a gland slidably coupled around the tube. The gland has a threaded exterior surface and forms a gland cavity adjacent the exterior surface of the tube. The tube assembly additionally includes a spring collar which is also slidably coupled around the tube. The spring collar has a circumferential groove and is positioned between the first end of the tube and the gland such that a portion of the spring collar is positioned within the gland cavity. The fitting assembly also has a fitting body with an inlet passage and a fitting cavity for receiving an end of the tube assembly. The open end of the fitting cavity has a threaded inner surface engaged with the exterior threaded surface of the gland to form a threaded engagement. This threaded engagement creates a first seal and a second seal between the tube assembly and the fitting body, and the second seal applies a force to the threaded engagement.

According to an alternate embodiment of the invention, a method for assembling a high pressure fitting is provided wherein a gland and a spring collar are slidably coupled around a tube such that the spring collar is located between a first end of the tube and the gland. A portion of the spring collar is positioned within a cavity formed between the gland and the tube. The first end of the tube is received within the fitting cavity of the fitting body. The first end of the tube has a chamfered inner diameter. This chamfered inner diameter of the first end of the tube is engaged with a complementary groove of the fitting cavity. The gland and spring collar are slid along the surface of the tube until a portion of the spring collar contacts a ramp portion of the fitting cavity. The threads of the gland are then engaged with the threads of the fitting cavity to connect the tube assembly to the fitting body.

According to yet another embodiment of the invention, a method is provided including providing a tube assembly. The tube assembly includes a tube having an undercut near a first end and a gland slidably coupled around the tube. The gland has a threaded exterior surface and forms a gland cavity adjacent the exterior surface of the tube. The tube assembly additionally includes a spring collar which is also slidably coupled around the tube. The spring collar is positioned between the first end of the tube and the gland such that a portion of the spring collar is positioned within the gland cavity. Also provided is a fitting body having an inlet passage and a fitting cavity for receiving an end of the tube assembly. The open end of the fitting cavity has a threaded inner surface engaged with the exterior threaded surface of the gland to form a threaded engagement. This threaded engagement creates a first seal and a second seal between the tube assembly and the fitting body, and the second seal applies a force to the threaded engagement.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cut-away side view of an exemplary high pressure fitting of the present invention after the high pressure fitting is partially assembled; and

FIG. 2 is a cut-away side view of the embodiment shown in FIG. 1 after the high pressure fitting is fully assembled.

The detailed description explains embodiments of the invention, together with advantages and features, by way of example with reference to the drawings.

### DETAILED DESCRIPTION OF THE INVENTION

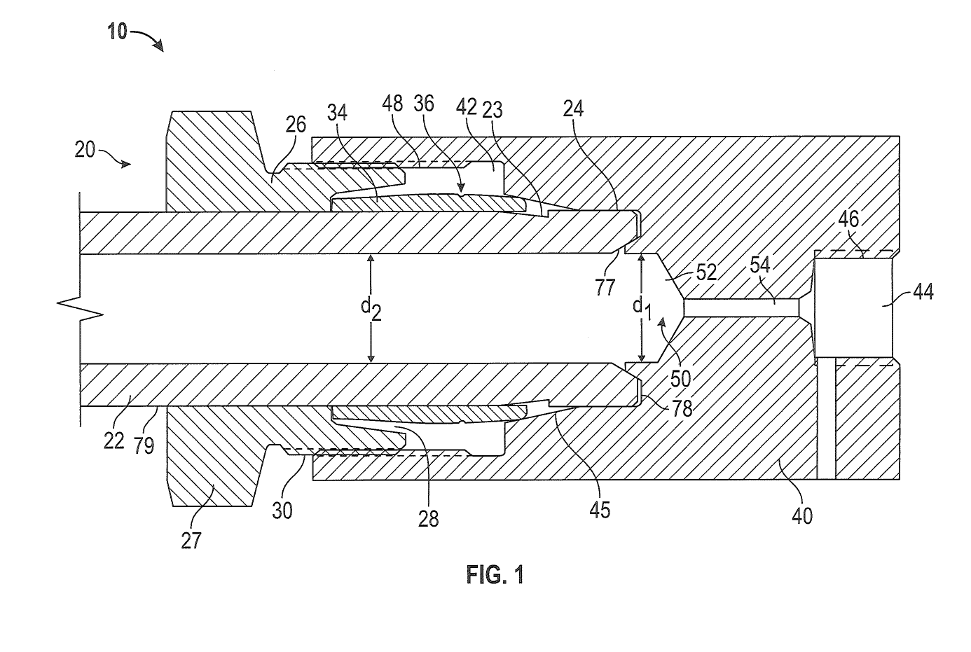

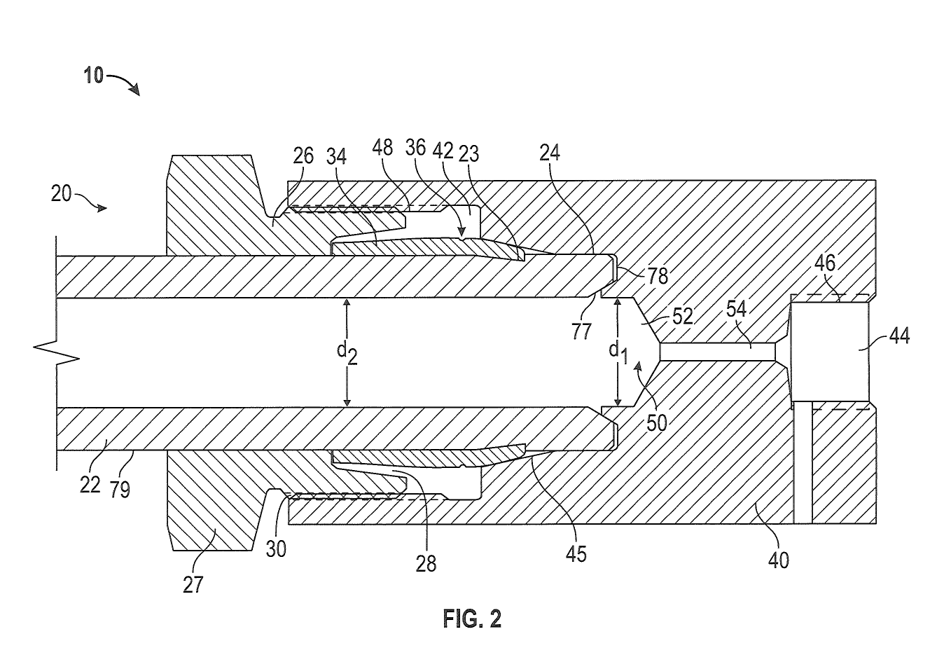

With reference to the FIGS., there is illustrated therein a high pressure fitting assembly 10 shown partially (FIG. 1) and fully assembled (FIG. 2) made in accordance with the teachings of the present invention. The fitting assembly 10 includes a tube assembly 20 and a fitting body 40 having a fitting cavity 42 within which an end of the tube assembly 20 is inserted.

As illustrated, the tube assembly 20 includes a tube 22, a gland 26, and a spring collar 34. The tube 22 has an undercut 23 formed on an exterior surface 79 thereof and near a first end 24. The first end 24 of the tube 22 is received within the fitting cavity 42. In the illustrated embodiment, the first end 24 has a chamfered inner edge 77. It shall be understood, however that in one embodiment, the first end 24 does not require the chamfered inner edge 77. As illustrated, the chamfered inner edge 77 is sized and arranged such that the first end 24 may mate with and be received in a groove 78 formed in the fitting cavity 42.

The gland 26 is disposed in close fitting sliding engagement with the tube 22 and forms a gland cavity 28 adjacent the exterior surface 79 of the tube 22. In the illustrated embodiment, the gland 26 is made of metal and has a radially outwardly extending flange 27 on one end thereof to provide additional strength for torqueing flange 27 to fitting body 40. The gland 26 has an exterior threaded surface 30 for connecting the tube assembly 20 to the fitting body 40. The spring collar 34 is also slidably engaged with the tube 22 and is positioned adjacent the gland 26 and near the undercut 23. Beginning at a first end, a portion of the spring collar 34 is disposed within the gland cavity 28. In one embodiment, the gland cavity and the first end of the spring collar 34 are formed such that there is minimal clearance between them when they are engaged in a manner illustrated in FIGS. 1 and 2. Spring collar 34 includes a circumferential groove 36 about which the spring collar 34 will bend when a force is applied to the end of the spring collar 34 adjacent the undercut 23.

As is best illustrated by comparing FIG. 1 to FIG. 2, as the gland 26 is threaded into the fitting cavity 42, the gland causes the spring collar 34 to be forced into engagement with the undercut 23. In one embodiment, the spring collar 34 is made of a deformable material such that compression of the fitting body 40 against the spring collar 34 creates a high pressure seal and reduces the potential for leakage of a fluid. In an exemplary embodiment of the invention, the spring collar 34 may be made from a nickel-chromium alloy such as Inconel®.

The illustrated fitting body 40 includes a first fitting cavity 42 in fluid communication connected to an inlet passage 50. The inlet passage 50 includes a cone-shaped inlet 52 having a diameter d₁ equal to or smaller than the inner diameter d2 of the tube 22. The inlet passage 50 also includes a stem 54 which continues the high pressured fluid flow to a second component (not shown) connected at the opposite end of the fitting body 40 at a second fitting cavity 44. Threads 46 for connecting the fitting body 40 to a second component may be located on an interior surface of the second fitting cavity 44, as shown in the figures. In another embodiment, threads 46 may be located on an exterior surface of the fitting body 40 near the second fitting cavity 44. As discussed above, the first fitting cavity 42 includes groove 78 for receiving the chamfered end 24 of the tube 22. The profile of groove 78 is complementary to the profile of the end 24 of the tube 22 being received in the groove 78. A ramp portion 45 of the first fitting cavity 42 tapers from a smaller diameter near the end 24 of the tube to a larger diameter in the direction of the spring collar 34. This ramp portion 45 of the first fitting cavity 42 engages an end of the spring collar 34 and guides the spring collar into the undercut 23 of the tube 22 during assembly of the fitting 10. The open end of the first fitting cavity 42 has a threaded inner surface 48 to engage the threaded external surface 30 of the gland 26.

To assemble the fitting assembly 10, both the gland 26 and the spring collar 34 are slid onto the tube 22 near the first end 24. The spring collar 34 is positioned adjacent the gland 26 such that a portion of the spring collar 34 is positioned within the gland cavity 28. The chamfered end 24 of the tube assembly 20 is then located within the groove 78 in the fitting cavity 42 such that the center of the tube 22 aligns with the cone-shaped inlet 52. This contact between the chamfered inner edge 77 of tube 22 and the complementary groove 78 of the fitting cavity 42 forms a primary seal to prevent leakage of high pressure fluid in the fitting 10. In one embodiment, after the first end 24 of the tube 22 is in contact with groove 78, the gland 26 and the spring collar 34 are slid along the surface of the tube 22 until an end of the spring collar 34 comes into contact with the ramp portion 45 of the first fitting cavity 42.

In another embodiment, the exterior threaded surface 30 may contact the inner threaded surface 48 before the spring collar 34 comes into contact with the ramp portion 45. Regardless, the exterior threaded surface 30 of the gland 26 is then threaded with the inner threaded surface 48 of the fitting cavity 42. This engagement causes the gland cavity 28 to bear against the spring collar 34, forcing the spring collar 34 further against the ramp portion 45 of the fitting cavity 42. The force applied by the gland 26 combined with the angle of the ramp portion 45 causes the end of the spring collar 34 to bend about circumferential groove 36 and engage the undercut 23 of the tube 22. When the fitting 10 is assembled, the spring collar 34 is compressed between the tube 22 and the ramp portion 45 of the first fitting cavity 42 thereby creating a secondary seal. Vibrations in the assembly 10, including the pulses of pressure which often cause failure in conventional fittings, are absorbed by the spring collar 34. Additionally, because the spring collar 34 applies a constant reactionary force on the gland 26 when the tube assembly 20 and the fitting body 40 are engaged, tension is applied to the threaded engagement of the gland 26 and the fitting body 40 such that vibrations will not cause the threads to loosen as in conventional fittings.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fitting assembly for use in a high pressure system comprising:
a tube assembly including:
a tube having an undercut near a first end;
a gland slidably coupled around the tube and having a threaded exterior surface, the gland forming a gland cavity adjacent an exterior surface of the tube; and
a spring collar slidably coupled around the tube between the first end and the gland such that a portion of the spring collar is disposed within the gland cavity; and
a fitting body having an inlet passage and a fitting cavity connected to the inlet passage into which an end of the tube assembly is received, an open end of the fitting cavity having a threaded inner surface engaged with the threaded exterior surface of the gland to form a threaded engagement such that a first seal and a second seal are formed between the tube assembly and the fitting body, wherein the second seal applies a force to the threaded engagement.

2. The fitting assembly according to claim 1, wherein the first seal is created between the end of the tube and the fitting cavity.

3. The fitting assembly according to claim 1, wherein the second seal is formed between the spring collar and the fitting cavity.

4. The fitting assembly according to claim 3, wherein the spring collar is engaged with the undercut of the tube.

5. The fitting assembly according to claim 3, wherein the spring collar includes a circumferential groove.

6. The fitting assembly according to claim 1, wherein the tube, spring collar, and gland are made of metal.

7. The fitting assembly according to claim 6, wherein the spring collar is made from a nickel-chromium alloy.

8. The fitting assembly according to claim 1, wherein an inner surface of the first end of the tube is chamfered.

9. A method comprising:
providing a tube assembly including:
a tube with a first end and having an undercut near the first end;
a gland slidably coupled around the tube and having a threaded exterior surface, the gland forming a gland cavity adjacent an exterior surface of the tube; and
a spring collar being slidably coupled around the tube adjacent the gland such that a portion of the spring collar is disposed within the gland cavity; and
providing a fitting body having an inlet passage and a fitting cavity for receiving the tube assembly, the fitting cavity having an open end with a threaded inner surface for engagement with the threaded exterior surface such that when the threaded inner surface and the threaded exterior surface are engaged to form a threaded engagement, a first seal and a second seal are formed between the tube assembly and the fitting body, wherein the second seal applies a force to the threaded engagement.

10. The method according to claim 9, wherein the first seal is created between the end first of the tube and the fitting cavity.

11. The method according to claim 9, wherein the second seal is formed between the spring collar and the fitting cavity.

12. The method according to claim 9, wherein the tube, spring collar, and gland are made of metal.

13. The method according to claim 12, wherein the spring collar is made from a nickel-chromium alloy.

14. The method according to claim 9, wherein an inner surface of an end of the tube received within the fitting cavity is chamfered.

15. A method of assembling a high pressure fitting comprising:
slidably coupling a gland and a spring collar around a tube such that a portion of the spring collar is positioned within a cavity formed between the gland and the tube and is located between the gland and a first end of the tube;
receiving the first end of the tube within the fitting cavity of the fitting body;
engaging a chamfered inner diameter of the first end of the tube with a complementary groove of the fitting cavity;
sliding the gland and spring collar along the surface of the tube until a portion of the spring collar contacts a ramp portion of the fitting cavity; and
engaging the threads of the gland with the threads of the fitting cavity.

16. The method of assembling a fitting according to claim 15, wherein engaging the threads of the gland with the threads of the fitting cavity applies a force to the spring collar causing an end of the spring collar to bend into an undercut on the tube.

17. The method of assembling a fitting according to claim 15, wherein the tube, spring collar, and gland are made of metal.

18. The method of assembling a fitting according to claim 17, wherein the spring collar is made from a nickel-chromium alloy.

19. The method of assembling a fitting according to claim 15, wherein a first seal is created between the end of the tube and the fitting cavity.

20. The method of assembling a fitting according to claim 15, wherein a second seal is formed between the spring collar and the fitting cavity.
